(19) United States
(12) Patent Application Publication
(10) Pub. No.: US 2026/0269288 A1
(43) Pub. Date: Sep. 10, 2026

(54) FUEL CELL GROUP FOR GENERATING ELECTRIC ENERGY

(71) Applicant: AVL List GmbH, Graz (AT)

(72) Inventors: David WEINGRILL, Stallhofen (AT); Katharina WEINGRILL, Stallhofen (AT)

(73) Assignee: AVL List GmbH, Graz (AT)

(21) Appl. No.: 19/165,149

(22) PCT Filed: Mar. 14, 2024
(86) PCT No.: PCT/AT2024/060090

§ 371 Date: Sep. 15, 2025

(30) Foreign Application Priority Data
Mar. 15, 2023 (AT) A 50199/2023

(51) Int. Cl. H01M 8/04225; H01M 8/04537; H01M 8/04858; H01M 8/04992; H01M 8/249

(52) U.S. Cl. CPC H01M 8/04225; H01M 8/04619; H01M 8/0494; H01M 8/04992; H01M 8/249

(57) ABSTRACT

The present invention relates to a fuel cell group (10) for generating electrical energy, comprising a main fuel cell system (100) with at least one main fuel cell stack (120) and at least one auxiliary fuel cell system (200) with at least one auxiliary fuel cell stack (220), wherein the main fuel cell system (100) and the at least one auxiliary fuel cell system (200) are electrically connected in parallel, wherein the main fuel cell system (100) has a main control module (110) for variable control of a variable main operating point (HBP) and the auxiliary fuel cell system (200) has an auxiliary switching module (210) for switching between an off-state (AZ) and at least one specified on-state (EZ).

The present invention relates to a fuel cell group for generating electrical energy, a method for operating such a fuel cell group, and a computer program product for carrying out such a method.

It is known that fuel cells are used to generate electrical energy for stationary or mobile applications. Individual fuel cells are often arranged in fuel cell stacks and form individual fuel cell systems. A fuel cell system can have one or more fuel cell stacks and requires appropriate connections and connection components for operation, such as supply lines, discharge lines, control valves, cooling devices and the like. In stationary use for the generation of electrical energy in particular, it is also known for different fuel cell systems to be combined to form a fuel cell group, thus enabling a modular multiplication of the electrical power provided.

A disadvantage of the known solutions for fuel cell groups is that the complexity can increase with the number of individual fuel cell systems used. Each of these fuel cell systems is an independent and fully functional fuel cell system with corresponding connections, control components and the like.

It is the object of the present invention to provide an efficient fuel cell group. In particular, it is the object of the present invention to provide equivalent or even better variability in the operation of a fuel cell group in a cost-effective and simple manner, in particular with reduced cost and/or complexity.

The above problem is solved by a fuel cell group with the features of claim 1, a method with the features of claim 8 and a computer program product with the features of claim 13. Further features and details of the invention are disclosed in the dependent claims, the description and the drawings. Naturally, features and details described in connection with the fuel cell group according to the invention also apply in connection with the method according to the invention and the computer program product according to the invention and vice versa, so that with regard to disclosure mutual reference is or can always be made to the individual aspects of the invention.

A fuel cell group according to the invention is used to generate electrical energy. This can be designed for both mobile and stationary use. Such a fuel cell group has a main fuel cell system with at least one main fuel cell stack. Furthermore, such a fuel cell group is equipped with at least one auxiliary fuel cell system with at least one auxiliary fuel cell stack. The main fuel cell system and the at least one auxiliary fuel cell system are electrically connected to each other in parallel. A fuel cell group according to the invention is characterised in that the main fuel cell system has a main control module for variable control of a variable main operating. The auxiliary fuel cell system is equipped with an auxiliary switching module for switching between an off-state and at least one specified on-state.

A fuel cell group according to the invention is based on the fundamental idea that, by electrically connecting two or more fuel cell systems in parallel, a multiplication of the maximum available power is made possible. This modular design serves, in the known way, to provide in a simple manner a high and thus multipliable power output capacity for such a fuel cell group in different application situations. However, in contrast to the known solutions, the main fuel cell system and the at least one auxiliary fuel cell system are designed differently with regard to at least one crucial design feature. The main fuel cell system is a classic fuel cell system that has a main control module to carry out a variable control of operation. A main operating point can, for example, be an operating point with regard to the electrical power generated in this mode of operation. In particular, a variable main operating point can thus be completely and continuously variable and thus provide a completely variable control option, so that the main fuel cell system can substantially approach a wide variety of different operating points as main operating points in a completely flexible manner. In other words, the main fuel cell system is able to control the output electrical power completely variably depending on the main operating point and thus variably meet different power requirements.

The auxiliary fuel cell system lacks such variable control by means of a control module. Rather, this is replaced by a simple auxiliary switching module. It can already be seen here that a switching module no longer enables variable control, but only switching between specified states. These specified states are an off-state and at least one specified on-state. A particularly simple embodiment of such an auxiliary fuel cell system has an auxiliary switching module which has exactly one specified on-state which for example corresponds to 100% of the maximum electrical power that can be output. It is thus possible that the auxiliary switching module no longer varies the operating point of the auxiliary fuel cell system variably, in a complex and controlling manner, but only switches the auxiliary fuel cell system on or off. In other words, in the on-state the auxiliary fuel cell system can provide and output the maximum electrical power which it can provide, or not, when it is in the off-state.

From a design point of view, the main advantage of the fuel cell group according to the invention is that the auxiliary fuel cell system can be significantly simplified by dispensing with a variable control option. In particular, various sensors, bypasses, flow control valves and the like can be dispensed with. The subsequent effort involved in monitoring and switching the auxiliary fuel cell system is also significantly reduced, since a complex variable control loop is no longer necessary. In particular, the auxiliary fuel cell system can be easily switched in a controlling manner, while the main control module for the main fuel cell system has to provide a control loop with feedback information on the actual operating status of the main fuel cell system. Another example of a reduction in complexity is that the humidity preferably no longer has to be controlled, as in particular the control loop with the humidity sensor and the humidifier bypass valve can be dispensed with. In addition, for such a simple auxiliary fuel cell system, smaller humidifiers, or no humidifiers at all, can in particular be provided. It should also be pointed out that special operating situations, for example a start-up of the fuel cell group, in particular in the form of a cold start at cold ambient temperatures, must be taken into account for the main fuel cell system. For example, pre-heating elements or the like can be provided exclusively in the main fuel cell system, so that the single or multiple auxiliary fuel cell systems can also dispense with such cost-intensive additional components. Accordingly, such special operating situations are therefore always provided and covered by the main fuel cell system, for example during a cold start. The auxiliary fuel cell systems are used exclusively to multiply the power which can be ouput by the fuel cell group in regular normal operation of the fuel cell group.

It can bring advantages if, in a fuel cell group according to the invention, the auxiliary fuel cell system and/or the auxiliary switching module are designed for switching between an off-state and exactly one single, specified on-state. While the basic concept of reducing complexity for auxiliary fuel cell systems is already achieved if two or more on-states are distinguishable from each other and switchable in a specified manner, this advantage is further enhanced if only one on-state is specified. In particular, this one single on-state for the auxiliary fuel cell system is the maximum power of this auxiliary fuel cell system that can be output as continuous power, so that this embodiment can also be described as a binary mode of switching. In other words, in this embodiment the auxiliary switching module is designed in such a way that it can either completely switch off the auxiliary fuel cell system or switch it on completely to the desired maximum power output. A variation between this one off-state and this single on-state is no longer necessary and therefore no longer possible with the simplified design of the auxiliary fuel cell system. The reduction to a single specified on-state thus enhances the advantages that can be achieved with a fuel cell group according to the invention.

Further advantages can be achieved if, in a fuel cell group according to the invention, the auxiliary fuel cell system is designed without at least one of the following components:
bypass valve for supply air humidifiers,
bypass valve for supply air turbines,
water separators for exhaust air,
thermostatic valve for cooling circuit,
heat exchangers for fuel supply and/or fuel removal,
purge valve for fuel exhaust gas,
temperature sensor at the stack inlet of the cooling circuit,
temperature sensor at the stack outlet of the cooling circuit,
pressure sensor in the exhaust section.

The above list is a non-exhaustive list. Of course, it is preferable to remove two or more, in particular all dispensable components from the design of the auxiliary fuel cell system, so that the reduction of the complexity of the auxiliary fuel cell system is optimised, in particular maximised. It is easy to see that not only is it possible to reduce complexity in terms of lower costs, but also that a reduction in components leads to a smaller space requirement and reduced wear. Last but not least, it should also be pointed out here that the exact switching between a single off-state and one or more predefined on-states can be specified in such a way that undesirable operating situations in partial load ranges which would be associated with increased wear or increased aging of the auxiliary fuel cell system can substantially be completely excluded. As a result, the wear caused by such partial load ranges is focused on the main fuel cell system, and the auxiliary fuel cell systems can accordingly be used with a mode of operation involving significantly less wear.

It can bring further advantages if, in a fuel cell group according to the invention, the fuel cell group has exactly one main fuel cell system and/or at least two auxiliary fuel cell systems. This means that simple scalability is provided with two or more fuel cell systems, which can have identical or different designs, as will be explained later. This embodiment shows particularly well the possible modular design of such fuel cell groups, in particular with regard to the fact that, regardless of the size of the fuel cell group and in particular regardless of the number of auxiliary fuel cell systems, exactly one main fuel cell system is always provided. In other words, when scaling the fuel cell group with regard to the necessary electrical power to be output, only the number of inexpensive and simple auxiliary fuel cell systems is increased until the desired output power can be provided. Only one single expensive and complex main fuel cell system is sufficient to provide the desired flexibility in meeting power requirements with the control method explained in more detail later.

It is also advantageous if, in a fuel cell group according to the invention, at least two auxiliary fuel cell systems are provided with an identical or substantially identical power output. In this way, the modular structure of such a fuel cell group is further optimised, since preferably all auxiliary fuel cell systems are designed with an identical or substantially identical power ouput. This allows for significantly simplified control and, in particular, simplified scalability. The cost expenditure in the case of identical auxiliary fuel cell systems is also significantly reduced in terms of design, installation, but also production. In other words, arbitrary scaling can be achieved, so that with each increase in the maximum necessary power output for the fuel cell group, the corresponding necessary number of auxiliary fuel cell systems can be added in the design of the fuel cell group by simple factorisation.

It can also bring advantages if, in a fuel cell group according to the invention, at least two fuel cell systems with different power outputs are provided. If necessary, the different power outputs of the auxiliary fuel cell systems can double in each case. Of course, such an embodiment with auxiliary fuel cells of different sizes can also be combined with a fuel cell group in which two or more identical auxiliary fuel cell systems are provided. In the sense of the present invention, identical or different auxiliary fuel cell systems is to be understood as meaning, in particular, the identical power output as the maximum power output. Preferably however, such identical auxiliary fuel cell systems are also of identical or substantially identical design in terms of the components, construction designs or the like.

In addition, it can bring advantages if, in a fuel cell group according to the invention, at least one main fuel cell system has the same or a greater power ouput than a smallest auxiliary fuel cell system. The identical power ouput relates to the auxiliary fuel cell system with the lowest power ouput of all the auxiliary fuel cell systems added in the design. Because the main fuel cell system does not have the smallest power ouput, but rather a greater power ouput than the smallest auxiliary fuel cell system, it is always possible to switch from the main fuel cell system to the auxiliary fuel cell system when the maximum power ouput of this smallest auxiliary fuel cell system is exceeded. This becomes apparent as a constructive advantage and in particular is illustrated even more clearly by the later explanation of the different control methods.

The subject matter of the present invention also includes providing a method for controlling a fuel cell group according to the invention, comprising the following steps:
registering a power requirement of the fuel cell group,
determining the necessary number of auxiliary fuel cell systems to be operated in the specified on-state to meet the registered power requirement,
determining the necessary main operating point for the main fuel cell system which is to be operated variably in order to meet the difference between the power of the auxiliary fuel cell system to be operated and the registered power requirement,
specifying the determined number of auxiliary fuel cell systems and the determined main operating point of the main fuel cell system for the operation of the main fuel cell system.

Due to the use of a fuel cell group according to the invention, a method according to the invention brings with it the same advantages as have been explained in detail with reference to a fuel cell group according to the invention. According to the invention, by registering the power requirement it is now specified in a known way which amount of electrical power must be made available by the fuel cell group. In a determination step, the registered power requirement is now divided as optimally as possible by means of the control method according to the invention. In this first step, it is thus determined how many auxiliary fuel cell systems are necessary to fulfil in particular an integral multiple as the main part of the power requirement through operation in the respective specified on-state. Only the remaining difference from this main part met by the auxiliary fuel cell systems, which depends, variably, on the actual power requirement, is then covered by the main fuel cell system, since only this can be operated variably in this way. For subsequent operation, the selected and determined auxiliary fuel cell systems are thus switched from the off-state to an on-state and, for complete fulfilment of the power requirement, the remaining difference being generated by the corresponding variable control and setting of the variable main operation by means of the main fuel cell system.

It can bring advantages if, in a method according to the invention, in order to determine the necessary number of auxiliary fuel cell systems to be operated, of the possible components, the combination with the lowest number is selected and specified in the final step. Usually, in particular in complex fuel cell groups with two or significantly more auxiliary fuel cell systems, there will be numerous situations in which a power requirement can be met by different combinations from the plurality of auxiliary fuel cell systems. In this embodiment of the method according to the invention, the combination is chosen which activates the minimum number of auxiliary fuel cell systems. This leads to a reduction in wear, since the minimum number of auxiliary fuel cell systems is always operated.

Alternatively or additionally, it can bring advantages if, in a method according to the invention, when specifying the number of auxiliary fuel cell systems, preference is given to those which are already in an on-state at the time of specification. This can be specified as a single optimisation or selection step or can be combined with other optimisation specifications. If a fuel cell group is already in an operating situation in which a current power requirement is met, the power requirement can change, for example increase. Now, when specifying the number of auxiliary fuel cell systems for the now increased power requirement, either a free recombination of all auxiliary fuel cell systems can be carried out and/or the already-running auxiliary fuel cell systems and thus their current operating status can be taken into account. In other words, this may mean that, contrary to the embodiment according to the preceding paragraph, while it is not the lowest number of all possible combinations of the auxiliary fuel cell systems which is selected in order to meet the power requirement, the number of switching operations is however reduced by continuing to operate auxiliary fuel cell systems that are already running when the power requirement increases or changes.

It can also be advantageous if, in a method according to the invention, the specification of the number of auxiliary fuel cell systems takes into account their proximity to the main fuel cell system. This is in particular the case in special operating situations, for example a cold start. As has already been explained, auxiliary fuel cell systems can be designed much more simply in terms of their construction design and components. With regard to cold-start situations, they can for example dispense with their own pre-heating devices, since they are only switched on at a time when the pre-heating of a significant part of the fuel cell group has already taken place through the operation of the main fuel cell system. In particular in such cold-start situations, the time taken for the heat generated by the main fuel cell system to spread differs depending on its proximity to the different auxiliary fuel cell systems. The closer an auxiliary fuel cell system is arranged, spatially, to the main fuel cell system in a cold start situation, the faster a temperature transfer to this nearest auxiliary fuel cell system will take place. Here, it is evident that this specification of the local correlation of an auxiliary fuel cell system to a main fuel cell system can also be specified temporarily, for example exclusively at defined ambient temperatures, and/or exclusively with reference to a particular operating situation.

It can also be advantageous if, in a method according to the invention, the provided power output of at least one main fuel cell system and/or of at least one auxiliary fuel cell system is monitored and compared with the power requirement. In other words, it is possible here, by means of the control method, to integrate a control loop which not only allows the desired power requirement to be met in a controlled manner, but also makes it possible to monitor and recognise the degree of fulfilment of the current power requirement. This enhances the advantages of the invention even further, since such fulfilment can also actually be monitored in a quantitative manner.

The subject of the present invention also includes a computer program product comprising commands which, when run by a computer, cause it to carry out the steps of the method according to the present invention. Thus, such a computer program product also brings with it the same advantages as have been explained in detail with reference to a method according to the invention.

Further advantages, features and details of the invention are explained in the following description, in which exemplary embodiments of the invention are described in detail with reference to the drawings. In each case schematically:

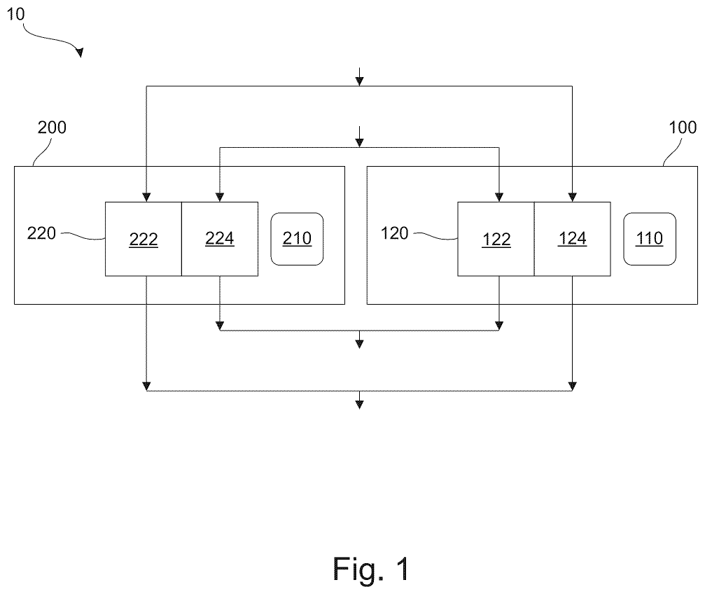

FIG. 1 shows an embodiment of a fuel cell group according to the invention,

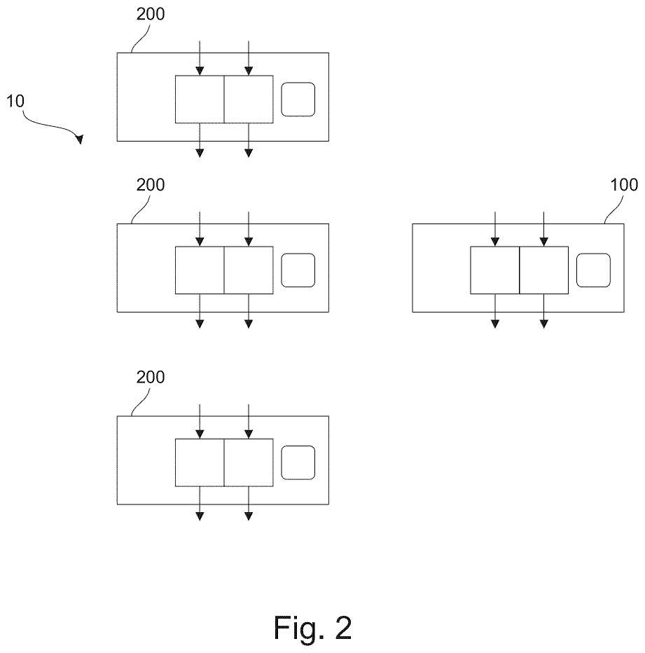

FIG. 2 shows another embodiment of a fuel cell group according to the invention,

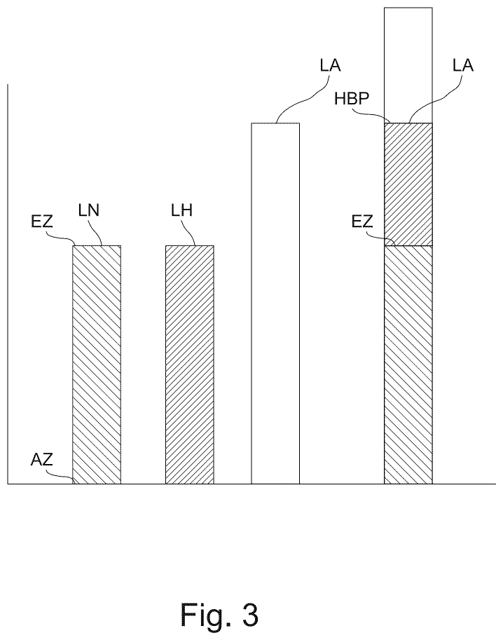

FIG. 3 shows a possible operating situation,

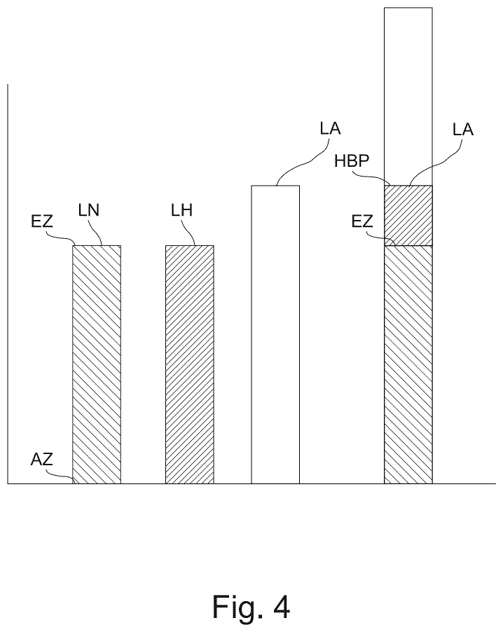

FIG. 4 shows another possible operating situation,

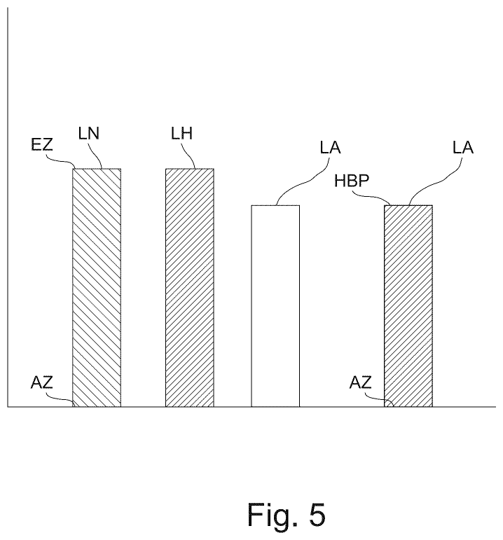

FIG. 5 shows another possible operating situation,

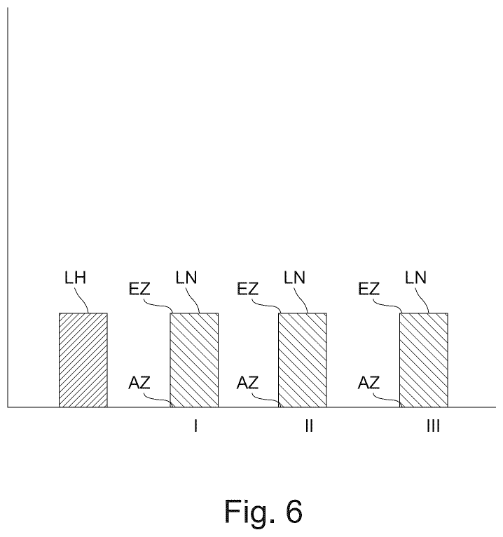

FIG. 6 shows possible different power outputs in a fuel cell group,

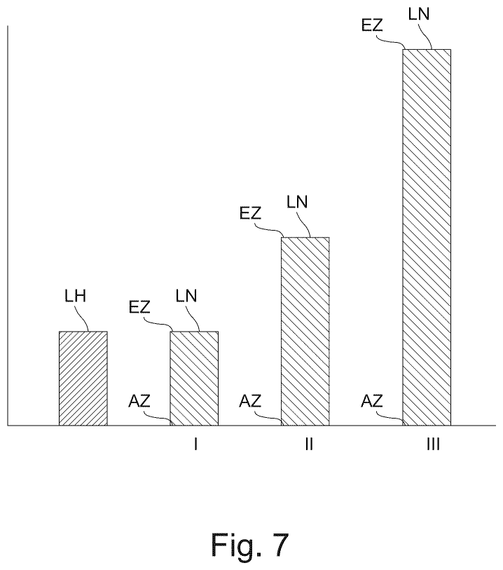

FIG. 7 shows other possible power outputs within a fuel cell group.

FIG. 1 shows, schematically, a fuel cell group 10. This is equipped, in this case, with a main fuel cell system 100 and a single auxiliary fuel cell system 200. The main fuel cell system 100 has a main fuel cell stack 120 with a main anode section 122 and a main cathode section 124. Appropriate gas supply sections and gas discharge sections are provided here in order to feed the desired supply gas to the main fuel cell system and to conduct the resulting exhaust gas away from this. In the same way, an auxiliary fuel cell system 200 is provided in the fuel cell group 10, with an auxiliary fuel cell stack 220 which in turn has an auxiliary anode section 222 and an auxiliary cathode section 224.

As can clearly be seen from FIG. 1, control and switching takes place at the system level. For this purpose, a main control module 110 is arranged in the main fuel cell system 100 which is able to influence the different control components, in particular valves or other devices, in order to be able to variably adjust a main operating point HBP of the main fuel cell system 100. No control possibility is provided in the auxiliary fuel cell system 200, only a switching possibility in the form of the auxiliary switching module 210, which is able to ensure, in particular, a simple activation and deactivation of this auxiliary fuel cell system 200. The exact switching functionality and logic will be explained in more detail below.

FIG. 2 shows a scaling of the embodiment of FIG. 1. Here, a single main fuel cell system 100 is again shown which can for example be designed in a similar or identical manner to FIG. 1. In addition, here too, three for example identical auxiliary fuel cell systems 200, are provided, each of which is equipped with its own individual auxiliary switching module 210. The switching logic for different operating situations is explained below.

FIG. 3 shows, on the left side of the diagram, that the main fuel cell system 100 has a power output LH which in this case corresponds substantially to the maximum power output LN of the auxiliary fuel cell system 200. Here it is already easy to see that the maximum power output LN of the auxiliary fuel cell system 200 is defined here as the only on-state EZ and complete shutdown is defined as the off-state AZ. In order to carry out a control method, in the first step a power requirement LA is registered which is higher than the individual maximum power outputs LN and LH and is represented by the third bar to the right. In order to meet this power requirement LA, it is clearly recognisable that, in a first step, the one auxiliary fuel cell system 200 is switched on, so that according to the stacking of the individual power outputs on the far right it is in the on-state EZ. Of the maximum possible power output LH of the main fuel cell system 200, only a part is needed to provide the missing difference, so that accordingly a variable main operating point HBP is set in such a way that the addition of the on-state EZ according to the auxiliary fuel cell system 200 and the main operating point HBP of the main fuel cell system 100 together result in exactly or substantially the exact power requirement LH and thus meet this.

FIG. 4 shows a variation in the operating situation compared to FIG. 3, which differs only in that a lower power requirement LH is now specified. However, the combination of the two modules, i.e. the main fuel cell system 100 and the auxiliary fuel cell system 200, is still always necessary to meet this slightly reduced power requirement LA. Nothing changes in the switching state of the auxiliary fuel cell system 200, since this remains in the on-state EZ. However, in contrast to FIG. 4, the remaining difference between the on-state EZ of the auxiliary fuel cell system 200 and the power requirement LA is reduced, so that accordingly the variable main operating point HBP can be set lower by the variable control influence of the main control module 110 and thus the main fuel cell system 100 can be operated with lower power. Nevertheless, here too the power requirement LA is met by the combined operation of the main fuel cell system 100 and the auxiliary fuel cell system 200.

FIG. 5 is also based on the explanation of FIGS. 3 and 4, but here the power requirement LA has been reduced even further, in particular below the maximum power output capabilities LH and LN of the main fuel cell system 100 and the auxiliary fuel cell system 200. Here it is easy to see that the auxiliary fuel cell system 200 is now switched to the off-state AZ and that the reduced power requirement LA can be met exclusively through a variable main operating point HBP that is again increased with respect to FIG. 4 by the main fuel cell system 100 alone.

FIGS. 6 and 7 show two differently designed possible configurations of a fuel cell group 10. According to FIG. 6, both the main fuel cell system 100 and also the three (I, II, III) auxiliary fuel cell systems 200 are in this case designed with identical power outputs LH and LN. The result is that, similarly to what has been explained with reference to FIGS. 3, 4 and 5, a combination of the individual auxiliary fuel cell systems 200 with the variation of the main operating point HBP, so to speak as in a puzzle, can meet the different power requirements LA. The maximum available power output results from the sum of the three power outputs LN and the one power output LH.

FIG. 7 shows a variant in which the different auxiliary fuel cell systems 200 differ in terms of maximum power output LN. Here, a doubling of the maximum power output LN from I to II and again to III can be seen. Here too, it is however possible, by switching on and off and varying the sole main fuel cell system 100, to meet any form of the power requirement LA variably by combining the control of the main fuel cell system 100 and switching of the auxiliary fuel cell system 200.

The above explanation of the embodiments describes the present invention exclusively in the context of examples.

### LIST OF REFERENCE SIGNS

10 fuel cell group
100 main fuel cell system
110 main control module
120 main fuel cell stack
122 main anode section
124 main cathode section
200 auxiliary fuel cell system
210 auxiliary switching module
220 auxiliary fuel cell stack
222 auxiliary anode section
224 auxiliary cathode section
HBP main operating point
AZ off-state
EZ on-state
LA power requirement
LN power of auxiliary fuel cell system
LH power of main fuel cell system

1. Fuel cell group (10) for generating electrical energy, comprising a main fuel cell system (100) with at least one main fuel cell stack (120) and at least one auxiliary fuel cell system (200) with at least one auxiliary fuel cell stack (220), wherein the main fuel cell system (100) and the at least one auxiliary fuel cell system (200) are electrically connected in parallel, wherein the main fuel cell system (100) has a main control module (110) for variable control of a variable main operating point (HBP) and the auxiliary fuel cell system (200) has an auxiliary switching module (210) for switching between an off-state (AZ) and at least one specified on-state (EZ).

2. Fuel cell group (10) according to claim 1, wherein the auxiliary fuel cell system (200) and/or the auxiliary switching module (210) are designed to switch between an off-state (AZ) and exactly one single, specified on-state (EZ).

3. Fuel cell group (10) according to claim 1, wherein the auxiliary fuel cell system (200) is designed without at least one of the following components:
bypass valve for supply air humidifier
bypass valve for supply air turbine
water separator for exhaust air
thermostatic valve for cooling circuit
heat exchanger for fuel supply and/or fuel removal
purge valve for fuel exhaust gas
temperature sensor at the stack inlet of the cooling circuit
temperature sensor at the stack outlet of the cooling circuit
pressure sensor in the exhaust section

4. Fuel cell group (10) according to claim 1, wherein the fuel cell group (10) has at least two auxiliary fuel cell systems (200).

5. Fuel cell group (10) according to claim 1, wherein at least two auxiliary fuel cell systems (200) are provided, with an identical or substantially identical power output (LN).

6. Fuel cell group (10) according to claim 1, wherein at least two auxiliary fuel cell systems (200) with different power outputs (LN) are provided.

7. Fuel cell group (10) according to claim 1, wherein at least one main fuel cell system (100) has the same or a greater power output (LH) than a smallest auxiliary fuel cell system (200).

8. Method for controlling a fuel cell group (10) with the features of claim 1, comprising the following steps:
registering a power requirement (LA) of the fuel cell group (10),
determining the necessary number of auxiliary fuel cell systems (200) to be operated in the specified on-state (EZ) in order to meet the registered power requirement (LA),
determining the necessary main operating point (HBP) for the main fuel cell system (100) which is to be operated variably in order to meet the difference between the power output of the auxiliary fuel cell systems (200) to be operated and the registered power requirement (LA),
specifying the determined number of auxiliary fuel cell systems

(200) and the determined main operating point (HBP) of the main fuel cell system (100) for the operation of the main fuel cell system (100).

9. Method according to claim 8, wherein, in determining the necessary number of auxiliary fuel cell systems (200) to be operated, of the possible combinations, the combination with the least number is selected and is also specified in the final step.

10. Method according to claim 8, wherein when specifying the number of auxiliary fuel cell systems (200), preference is given to those which are already in an on-state (EZ) at the specified time.

11. Method according to claim 8, wherein the specification of the number of auxiliary fuel cell systems (200) takes into account their proximity to the main fuel cell system (100).

12. Method according to claim 8, wherein following the specification, the provided power output of at least one main fuel cell system (100) and/or at least one auxiliary fuel cell system (200) is monitored and compared with the power requirement (LA).

13. Computer program product comprising commands which, when run by a computer, cause it to carry out the steps of a method with features of claim 8.
